(19) United States
(12) Patent Application Publication
(10) Pub. No.: US 2022/0091608 A1
(43) Pub. Date: Mar. 24, 2022

(54) METHOD, APPARATUS, AND ELECTRONIC DEVICE FOR OBSTACLE AVOIDANCE

(71) Applicant: AUTEL ROBOTICS CO., LTD., Shenzhen (CN)

(72) Inventor: Yinhua Feng, Shenzhen (CN)

(21) Appl. No.: 17/457,306

(22) Filed: Dec. 2, 2021

Related U.S. Application Data
(63) Continuation of application No. PCT/CN2020/094764, filed on Jun. 5, 2020.

(30) Foreign Application Priority Data
Jun. 6, 2019 (CN) 201910490281.6

(51) Int. Cl. G05D 1/00; G06V 20/17; G06V 20/20; B64C 39/02; G06V 20/58; G05D 1/10

(52) U.S. Cl. CPC G05D 1/0044; G05D 1/0038; G05D 1/005; G06V 20/17; B64C 2201/146; B64C 39/024; G06V 20/58; G05D 1/106; B64C 2201/127; G06V 20/20

(57) ABSTRACT

Embodiments of the present invention relate to a method, apparatus, and an electronic device obstacle avoidance. The method includes: obtaining obstacle data in a flight environment of an unmanned aerial vehicle (UAV) and an image captured by the UAV, where the obstacle data is obtained by the UAV based on the image, the obstacle data includes a physical location of an obstacle and an image location corresponding to the obstacle, and the physical location of the obstacle includes a distance and an orientation of the obstacle; recognizing the image to obtain a category of the obstacle; obtaining a virtual image of the obstacle based on the category of the obstacle; superimposing the virtual image on the image at the image location corresponding to the obstacle, to obtain a superimposed image; and displaying the superimposed image on a display screen of the electronic device.

### CROSS-REFERENCE TO RELATED APPLICATIONS

This present application is a continuation of International Application No. PCT/CN2020/094764, filed on Jun. 5, 2020, which claims priority to Chinese Patent Application No. 201910490281.6, filed on Jun. 6, 2019, which is incorporated herein by reference in its entirety.

### TECHNICAL FIELD

The present application relates to the field of unmanned aerial vehicle (UAV) technologies, and in particular, to a method, apparatus, and an electronic device obstacle avoidance.

### BACKGROUND

Currently, an unmanned aerial vehicle (UAV) mainly has three flight modes: autonomous flight, remote control, and a combination of autonomous flight and remote control. During flight, the UAV needs to avoid obstacles. In most existing obstacle avoidance methods, the UAV autonomously detects the location of the obstacle, and takes obstacle avoidance measures according to the location of the obstacle. Alternatively, the UAV transmits an image or video of the surrounding environment to the operator of the remote control. The operator visually determines the location of the obstacle by viewing the image or video, and controls the UAV to avoid the obstacle.

In the process of implementing the present invention, it is found by the inventor that the related art has at least the following problems: The method that the operator visually determines the location of the obstacle by viewing the image or video returned by the UAV cannot intuitively display the obstacle to the operator, resulting in a poor user experience.

### SUMMARY

An objective of embodiments of the present invention is to provide an method, apparatus, and an electronic device obstacle avoidance, which can intuitively display the obstacle to the operator of the unmanned aerial vehicle (UAV).

According to a first aspect, an embodiment of the present invention provides an obstacle avoidance method, applicable to an electronic device, the method including:

obtaining obstacle data in a flight environment of a UAV and an image captured by the UAV, where the obstacle data is obtained by the UAV based on the image, the obstacle data includes a physical location of an obstacle and an image location corresponding to the obstacle, and the physical location of the obstacle includes a distance and an orientation of the obstacle;

recognizing the image to obtain a category of the obstacle;

obtaining a virtual image of the obstacle based on the category of the obstacle;

superimposing the virtual image on the image at the image location corresponding to the obstacle, to obtain a superimposed image; and

displaying the superimposed image on a display screen of the electronic device, so that a user controls the UAV to avoid the obstacle according to the superimposed image.

In some embodiments, the superimposing the virtual image on the image at the image location corresponding to the obstacle, to obtain a superimposed image includes:

superimposing the virtual image on the image by using an augmented reality (AR) technology, to obtain the superimposed image.

In some embodiments, the method further includes:

performing a voice prompt according to the category of the obstacle and the physical location of the obstacle, so that the user learns the category and the physical location of the obstacle.

In some embodiments, the method further includes:

determining whether the distance of the obstacle is less than a preset safe distance threshold;

obtaining a status of an obstacle avoidance switch and a flight speed of the UAV if the distance of the obstacle is less than the preset safe distance threshold; and

sending an obstacle avoidance instruction to the UAV and/or performing a danger prompt if the obstacle avoidance switch is turned off and the flight speed is greater than a preset flight speed threshold.

In some embodiments, the method further includes:

determining a preset quantity of obstacles with the smallest distance among obstacles; then

the obtaining a virtual image of the obstacle based on the category of the obstacle includes:

obtaining virtual images corresponding to the preset quantity of obstacles based on categories of the preset quantity of obstacles.

According to a second aspect, an embodiment of the present invention provides an obstacle avoidance apparatus, applicable to an electronic device, the apparatus including:

an image and obstacle data obtaining module, configured to obtain obstacle data in a flight environment of a UAV and an image captured by the UAV, where the obstacle data is obtained by the UAV based on the image, the obstacle data includes a physical location of an obstacle and an image location corresponding to the obstacle, and the physical location of the obstacle includes a distance and an orientation of the obstacle;

a recognition module, configured to recognize the image to obtain a category of the obstacle;

a virtual image obtaining module, configured to obtain a virtual image of the obstacle based on the category of the obstacle;

a superimposing module, configured to superimpose the virtual image on the image at the image location corresponding to the obstacle, to obtain a superimposed image; and

a display module, configured to display the superimposed image on a display screen of the electronic device, so that a user controls the UAV to avoid the obstacle according to the superimposed image.

In some embodiments, the superimposing module is further configured to:

superimpose the virtual image on the image by using an AR technology, to obtain the superimposed image.

In some embodiments, the apparatus further includes:

a voice prompt module, configured to perform a voice prompt according to the category of the obstacle and the physical location of the obstacle, so that the user learns the category and the physical location of the obstacle.

In some embodiments, the apparatus further includes:

an auxiliary obstacle avoidance module, configured to: determine whether the distance of the obstacle is less than a preset safe distance threshold; obtain a status of an obstacle avoidance switch and a flight speed of the UAV if the distance of the obstacle is less than the preset safe distance threshold; and send an obstacle avoidance instruction to the UAV and/or perform a danger prompt if the obstacle avoidance switch is turned off and the flight speed is greater than a preset flight speed threshold.

In some embodiments, the apparatus further includes:

a nearest obstacle determining module, configured to determine a preset quantity of obstacles with the smallest distance among obstacles; and

the virtual image obtaining module is further configured to:

obtain virtual images corresponding to the preset quantity of obstacles based on categories of the preset quantity of obstacles.

According to a third aspect, an embodiment of the present invention provides an electronic device, including:

at least one processor; and

a memory communicatively connected to the at least one processor, where

the memory stores instructions executable by the at least one processor, and the instructions are executed by the at least one processor to cause the at least one processor to perform the foregoing method.

According to a fourth aspect, an embodiment of the present invention provides a non-volatile computer-readable storage medium storing computer-executable instructions. The computer-executable instructions, when executed by an electronic device, cause the electronic device to perform the foregoing method.

According to a fifth aspect, an embodiment of the present application further provides a computer program product, including a computer program stored in a non-volatile computer-readable storage medium. The computer program includes program instructions. The program instructions, when executed by an electronic device, cause the electronic device to perform the foregoing method.

According to the obstacle avoidance a method and apparatus, and the electronic device of the embodiments of the present invention, the image captured by the UAV and the obstacle data are obtained by using the electronic device. The obstacle data is obtained by the UAV based on the image. The electronic device recognizes the image, obtains the category of the obstacle, obtains the virtual image of the obstacle according to the category of the obstacle, superimposes the virtual image on the image at the image location corresponding to the obstacle to obtain the superimposed image, and displays the superimposed image on the display screen of the electronic device. The virtual image of the obstacle and the real image obtained by the UAV are superimposed and displayed, which can intuitively display the obstacle to the operator of the UAV, thereby achieving better user experience.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1a is a schematic diagram of one application scenario of an obstacle avoidance method and apparatus according to an embodiment of the present invention;

FIG. 1b is a schematic diagram of the other application scenario of the obstacle avoidance method and apparatus according to an embodiment of the present invention;

FIG. 2 is a schematic flowchart of an embodiment of an obstacle avoidance method according to the present invention;

FIG. 3 is a schematic flowchart of an embodiment of an obstacle avoidance method according to the present invention;

FIG. 4 is a schematic structural diagram of an embodiment of an obstacle avoidance apparatus according to the present invention;

FIG. 5 is a schematic structural diagram of an embodiment of an obstacle avoidance apparatus according to the present invention; and

FIG. 6 is a schematic diagram of a hardware structure of a controller of a path planning system in an embodiment of a UAV according to the present invention.

### DETAILED DESCRIPTION

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are merely some embodiments of the present invention rather than all of the embodiments. All other embodiments obtained by a person of ordinary skill in the art based on the embodiments of the present invention without creative efforts shall fall within the protection scope of the present invention.

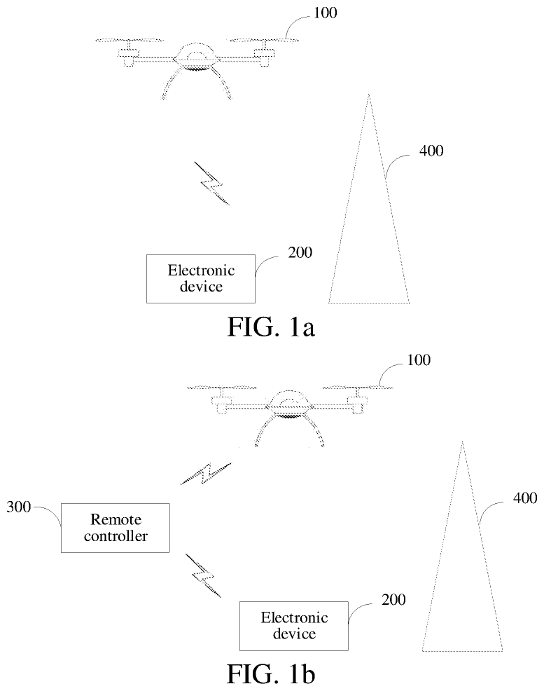

A method, apparatus, and an electronic device obstacle avoidance provided in the embodiments of the present invention are applicable to an application scenario shown in FIG. la. The application scenario includes a UAV 100, an electronic device 200, and an obstacle 400. The UAV 100 may be a suitable unmanned aircraft, including a fixed-wing unmanned aircraft and a rotary-wing unmanned aircraft, for example, a helicopter, a quadcopter, and an aircraft having other quantities of rotors and/or rotor configurations. The UAV 100 may be alternatively another movable object such as a manned aircraft, a model airplane, an unmanned airship, or an unmanned hot air balloon. The obstacle 400 is, for example, a person, an animal, a building, a mountain, a tree, a forest, a signal tower, or another movable or non-movable object (only one obstacle is shown in FIG. 1a, and there may be more obstacles or no obstacle during actual application). The electronic device 200 is, for example, a smartphone, a tablet computer, a computer, or a remote controller.

A communication connection may be established between the UAV 100 and the electronic device 200 by using wireless communication modules (for example, a signal receiver and a signal transmitter) configured in the UAV and the electronic device respectively for uploading or delivering data/instructions. When the electronic device 200 is a remote controller, the remote controller needs to be provided with a display screen to display an image or data returned by the UAV. When the electronic device 200 is a smartphone, a tablet, a computer, or the like, as shown in FIG. 1b, the application scenario may further include a remote controller 300. The electronic device 200 establishes a communication connection with the UAV 100 through the remote controller 300 (the application scenario shown in FIG. 1b is taken as an example for description below).

In some embodiments, the UAV 100 includes a fuselage, a wing connected to the fuselage, a power apparatus disposed on the wing, and a control system disposed on the fuselage. The power apparatus is configured to provide a thrust and a lift force for the UAV 100 to fly. The control system is a central nerve of the UAV 100, and may include a plurality of functional units, such as a flight control system, a vision system, and other systems with specific functions. The vision system includes an image acquisition apparatus, a vision chip, and the like. The flight control system includes various sensors (such as a gyroscope and an accelerometer), and a flight controller. The image acquisition apparatus may include at least one monocular camera or at least one binocular camera.

During flight, the UAV 100 needs to recognize and avoid the front obstacle 400. The UAV 100 may obtain an image around the UAV by using the image acquisition apparatus. The vision chip performs monocular or binocular recognition based on the image to obtain obstacle data around the UAV 100. The obstacle data is, for example, a distance (referred to as an obstacle distance below) between each obstacle and the UAV, an orientation of each obstacle relative to the UAV, and a coordinate location (referred to as an image location) of each obstacle in the image. The image, the obstacle data, or other data obtained by the UAV may be transmitted to the electronic device 200 through the remote controller 300.

In this embodiment of the present invention, after obtaining the image captured by the UAV and the obstacle data through the remote controller, the electronic device 200 recognizes the obstacle in the image, identifies a category of the obstacle, and obtains a virtual image of the obstacle according to the category of the obstacle. The virtual image may be a typical image representing the category of the obstacle. For example, if the recognized obstacle is a person, the virtual image may be a human-shaped image. The electronic device 200 then superimposes the virtual image on the image at the image location corresponding to the obstacle to obtain a superimposed image, and displays the superimposed image on a display screen of the electronic device 200. The virtual image of the obstacle and the real image obtained by the UAV are superimposed and displayed, which can intuitively display the obstacle to the operator of the UAV, thereby achieving better user experience.

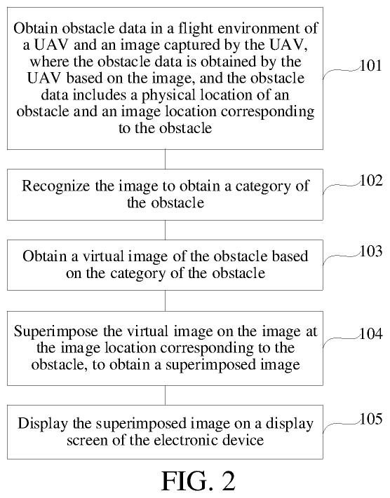

FIG. 2 is a schematic flowchart of an obstacle avoidance method according to an embodiment of the present invention. The method may be performed by the electronic device 200 in FIG. 1a or FIG. 1b. As shown in FIG. 2, the method includes the following steps:

101: Obtain obstacle data in a flight environment of a UAV and an image captured by the UAV, where the obstacle data is obtained by the UAV based on the image, the obstacle data includes a physical location of an obstacle and an image location corresponding to the obstacle, and the physical location of the obstacle includes a distance and an orientation of the obstacle.

In some embodiments, the electronic device 200 establishes a communication connection with the UAV through a remote controller, to receive image data, obstacle data, and the like sent by the UAV. In some other embodiments, the electronic device may alternatively directly establish a communication connection with the UAV, to directly receive the image data, the obstacle data, and the like sent by the UAV. After acquiring an image of the surrounding environment by using an image acquisition apparatus, the UAV performs monocular or binocular recognition based on the image, to obtain a physical location of each obstacle in the image. The physical location includes a distance, an orientation, and the like of the obstacle. The binocular recognition is taken as an example to illustrate the process of obtaining the obstacle data by the UAV. The UAV performs feature point extraction and feature point matching on a binocular image, uses a matching algorithm to obtain a disparity of the feature point on the binocular image, and then uses the disparity to obtain a depth value of the feature point, that is, a distance between the UAV and the feature point (an obstacle distance of the feature point). Further, physical coordinates of the obstacle and an orientation relative to the UAV can be obtained. Since a location of each feature point on the image is determined by an image location (for example, pixel coordinates) of the feature point, a physical location of each obstacle corresponds to an image location.

102: Recognize the image to obtain a category of the obstacle.

The image may be recognized by using a deep learning-based neural network model. In some embodiments, the deep learning-based neural network model may be pre-trained by using another apparatus, and then the neural network model is loaded on the electronic device. In some other embodiments, the deep learning-based neural network model may alternatively be trained by the electronic device. The neural network model may be obtained by training a large amount of sample data and labels (that is, categories) corresponding to the sample data, for example, based on data training on a PASCAL VOC data set. In some embodiments, the neural network model is a network model based on a single shot multibox detector (SSD) algorithm. In some other embodiments, the neural network model may be replaced by another deep learning network, for example, you only look once (YOLO), or regions with CNN (Fast-RCNN).

The image is inputted into the neural network model, to obtain a smallest circumscribed frame of each obstacle in the image and a category corresponding to the smallest circumscribed frame. The smallest circumscribed frame is, for example, a smallest circumscribed rectangular region that encloses the obstacle in the image. The smallest circumscribed frame where the image location is located is determined, to obtain the category of the obstacle at the image location.

103: Obtain a virtual image of the obstacle based on the category of the obstacle.

The virtual image may be a typical image representing the category of the obstacle. For example, if the recognized obstacle is a person, the virtual image may be a human-shaped image. If the recognized obstacle is a tree, the virtual image may be a tree-shaped image. If the recognized obstacle is a dog, the virtual image is an image of a dog. Each virtual image may be pre-stored in the electronic device. After the category of the obstacle is obtained, the corresponding virtual image may be called in the electronic device according to the category of the obstacle.

In this embodiment, after a virtual image of each obstacle in the image is obtained, each virtual image may be superimposed on the image sent by the UAV, to obtain a superimposed image. In some other embodiments, virtual images of several obstacles with the smallest distance may alternatively be superimposed on the image sent by the UAV. In this way, the poor distinguishing effect and customer experience due to too many virtual images in the superimposed image can be avoided.

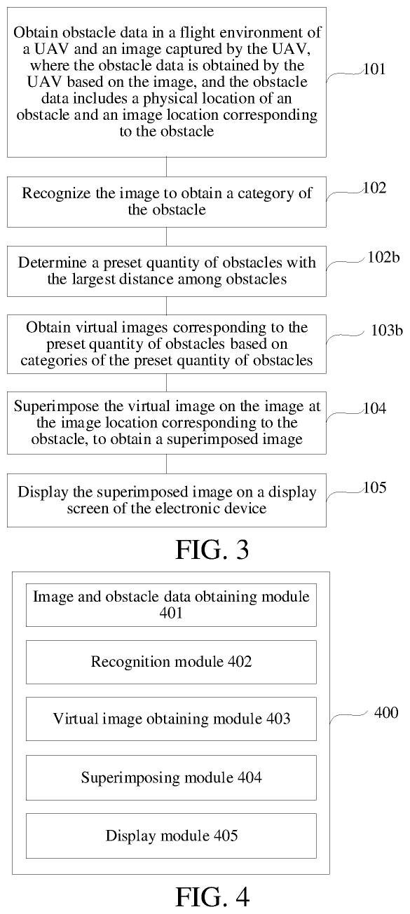

Specifically, before 103, a preset quantity of obstacles with the smallest obstacle distance among obstacles are first determined. For example, three obstacles with the smallest obstacle distance among obstacles are first obtained, and virtual images corresponding to the preset quantity of obstacles are then obtained. The preset quantity is three, four, or the like. The three obstacles with the smallest distance refer to the top three obstacles in the arrangement from small to large. For this embodiment, reference is made to FIG. 3. In the embodiment shown in FIG. 3, the method includes the following steps:

101: Obtain obstacle data in a flight environment of a UAV and an image captured by the UAV, where the obstacle data is obtained by the UAV based on the image, the obstacle data includes a physical location of an obstacle and an image location corresponding to the obstacle, and the physical location of the obstacle includes a distance and an orientation of the obstacle.

102: Recognize the image to obtain a category of the obstacle.

102b: Determine a preset quantity of obstacles with the smallest distance among obstacles.

103b: Obtain virtual images corresponding to the preset quantity of obstacles based on categories of the preset quantity of obstacles.

104: Superimpose the virtual image on the image at the image location corresponding to the obstacle, to obtain a superimposed image.

105: Display the superimposed image on a display screen of the electronic device, so that a user controls the UAV to avoid the obstacle according to the superimposed image.

104: Superimpose the virtual image on the image at the image location corresponding to the obstacle, to obtain a superimposed image.

The virtual image of the obstacle is superimposed on the image at the image location corresponding to the obstacle, to obtain the superimposed image.

In some embodiments, the virtual image of the obstacle may be superimposed on the image at the image location corresponding to the obstacle by using an augmented reality (AR) technology, to obtain the superimposed image.

It should be noted that, the obstacle avoidance by the UAV is a continuous process. In this process, an image obtaining apparatus continuously obtains an image of the surrounding environment of the UAV; and the UAV obtains a physical location of each obstacle in the image and an image location corresponding to the obstacle based on the image, and then transmits the image and obstacle data to the electronic device. The electronic device recognizes the image, obtains a category of the obstacle in the image, obtains a virtual image corresponding to the obstacle according to the category of the obstacle, and then superimposes the virtual image on the corresponding image sent by the UAV, to obtain a superimposed image. Since the UAV continuously obtains an image of the surrounding environment, the electronic device also continuously obtains a superimposed image, and displays the superimposed image on the electronic device, which can dynamically display obstacles around the UAV. The virtual image of the obstacle and the real image obtained by the UAV are superimposed and displayed, which can intuitively display the obstacle to the operator of the UAV, thereby achieving better user experience.

105: Display the superimposed image on a display screen of the electronic device, so that a user controls the UAV to avoid the obstacle according to the superimposed image.

The operator of the UAV can visually observe the obstacle by viewing the display screen of the electronic device. In some other embodiments, to further enhance the user experience, the user may be prompted by voice according to the category of the obstacle and the physical location of the obstacle. For example, if the category of the obstacle is a tree and the obstacle distance is 5 m, the user may be prompt by voice “there is a big tree five meters ahead”. The manners of displaying the superimposed image and performing the voice prompt are combined, so that the operator of the UAV can “see” and “hear” the state of the obstacle simultaneously, making it easier to learn the state of the obstacle.

After obtaining the physical location of the obstacle, the UAV may use an obstacle avoidance system thereof to perform an obstacle avoidance operation. However, in some application scenarios, the UAV turns off an obstacle avoidance switch, so that the obstacle avoidance system does not work. In this state, there is a risk in the flight of the UAV. Therefore, in some embodiments, to reduce the flight risk of the UAV, the electronic device may be used to assist the UAV in avoiding obstacles. In this embodiment, the method further includes:

determining whether the distance of the obstacle is less than a preset safe distance threshold;

obtaining a status of an obstacle avoidance switch and a flight speed of the UAV if the distance of the obstacle is less than the preset safe distance threshold; and

sending an obstacle avoidance instruction to the UAV and/or performing a danger prompt if the obstacle avoidance switch is turned off and the flight speed is greater than a preset flight speed threshold.

When a distance of an obstacle is less than the preset safe distance threshold among distances of obstacles, the status of the obstacle avoidance switch and the flight speed of the UAV are obtained. If the obstacle avoidance switch is turned off and the flight speed is greater than the preset flight speed threshold, the electronic device takes obstacle avoidance measures to assist the UAV in avoiding obstacles. Specifically, for example, a control instruction is sent to pause the UAV, or a control instruction is sent to instruct the UAV to turn on the obstacle avoidance switch, or a voice prompt is directly sent to prompt the operator of the UAV. The preset safe distance threshold, the preset flight speed threshold, and the like may be set according to the application situation, for example, the performance of the UAV.

Correspondingly, as shown in FIG. 4, an embodiment of the present invention further provides an obstacle avoidance apparatus. The apparatus is applicable to the electronic device shown in FIG. 1a or FIG. 1b. The obstacle avoidance apparatus 400 includes:

an image and obstacle data obtaining module 401, configured to obtain obstacle data in a flight environment of a UAV and an image captured by the UAV, where the obstacle data is obtained by the UAV based on the image, the obstacle data includes a physical location of an obstacle and an image location corresponding to the obstacle, and the physical location of the obstacle includes a distance and an orientation of the obstacle;

a recognition module 402, configured to recognize the image to obtain a category of the obstacle;

a virtual image obtaining module 403, configured to obtain a virtual image of the obstacle based on the category of the obstacle;

a superimposing module 404, configured to superimpose the virtual image on the image at the image location corresponding to the obstacle, to obtain a superimposed image; and

a display module 405, configured to display the superimposed image on a display screen of the electronic device, so that a user controls the UAV to avoid the obstacle according to the superimposed image.

According to the embodiments of the present invention, the image captured by the UAV and the obstacle data are obtained by using the electronic device. The obstacle data is obtained by the UAV based on the image. The electronic device recognizes the image, obtains the category of the obstacle, obtains the virtual image of the obstacle according to the category of the obstacle, superimposes the virtual image on the image at the image location corresponding to the obstacle to obtain the superimposed image, and displays the superimposed image on the display screen of the electronic device. The virtual image of the obstacle and the real image obtained by the UAV are superimposed and displayed, which can intuitively display the obstacle to the operator of the UAV, thereby achieving better user experience.

In some embodiments, the superimposing module 404 is further configured to:

superimpose the virtual image on the image by using an AR technology, to obtain the superimposed image.

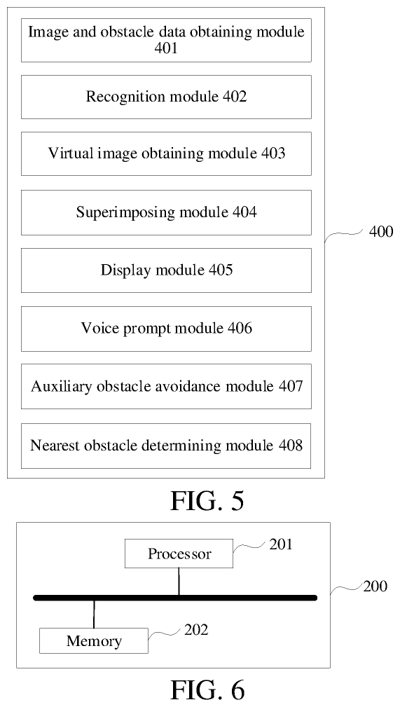

In some embodiments, referring to FIG. 5, the obstacle avoidance apparatus 400 further includes:

a voice prompt module 406, configured to perform a voice prompt according to the category of the obstacle and the physical location of the obstacle, so that the user learns the category and the physical location of the obstacle.

In some embodiments, referring to FIG. 5, the obstacle avoidance apparatus 400 further includes:

an auxiliary obstacle avoidance module 407, configured to: determine whether the distance of the obstacle is less than a preset safe distance threshold; obtain a status of an obstacle avoidance switch and a flight speed of the UAV if the distance of the obstacle is less than the preset safe distance threshold; and send an obstacle avoidance instruction to the UAV and/or perform a danger prompt if the obstacle avoidance switch is turned off and the flight speed is greater than a preset flight speed threshold.

In some embodiments, referring to FIG. 5, the obstacle avoidance apparatus 400 further includes:

a nearest obstacle determining module 408, configured to determine a preset quantity of obstacles with the smallest distance among obstacles; and

the virtual image obtaining module 403 is further configured to:

obtain virtual images corresponding to the preset quantity of obstacles based on categories of the preset quantity of obstacles.

It should be noted that, the foregoing apparatus may perform the method provided in the embodiments of the present application, and has the corresponding functional modules for performing the method and beneficial effects thereof. For technical details not described in detail in the apparatus embodiments, reference may be made to the method provided in the embodiments of the present application.

FIG. 6 is a schematic diagram of a hardware structure of an embodiment of an electronic device 200 according to the present invention. As shown in FIG. 6, the electronic device 200 includes:

one or more processors 201 and a memory 202. One processor 201 is taken as an example in FIG. 6.

The processor 201 and the memory 202 may be connected by using a bus or in another manner. A connection by using the bus is taken as an example in FIG. 6.

As a non-volatile computer-readable storage medium, the memory 202 may be configured to store a non-volatile software program, a non-volatile computer-executable program, and a module, for example, program instructions/modules (for example, the image and obstacle data obtaining module 401, the recognition module 402, the virtual image obtaining module 403, the superimposing module 404, and the display module 405 shown in FIG. 4) corresponding to the obstacle avoidance method in the embodiments of the present application. The processor 201 performs various functional applications and data processing of the electronic device by running the non-volatile software program, the instructions, and the modules stored in the memory 202, that is, implementing the obstacle avoidance method provided in the foregoing method embodiments.

The memory 202 may include a program storage area and a data storage area. The program storage area may store an operating system and an application program that is required for at least one function. The data storage area may store data created according to use of a controller. In addition, the memory 202 may include a high speed random access memory (RAM), and may further include a non-volatile memory, such as at least one magnetic disk storage device, a flash memory, or another volatile solid storage device. In some embodiments, the memory 202 may optionally include memories remotely disposed relative to the processor 201, and these remote memories may be connected to the electronic device through a network. Instances of the network include, but are not limited to, the Internet, an intranet, a local area network, a mobile communication network, and a combination thereof.

The one or more modules are stored in the memory 202, and perform, when executed by the one or more processors 201, the obstacle avoidance method in any of the foregoing method embodiments, for example, perform the foregoing described method steps 101 to 105 in FIG. 2, and method steps 101 to 105 in FIG. 3; and implement the functions of the modules 401 to 405 in FIG. 4, and the functions of the modules 401 to 408 in FIG. 5.

The foregoing product may perform the method provided in the embodiments of the present application, and has the corresponding functional modules for performing the method and beneficial effects thereof. For technical details not described in detail in this embodiment, reference may be made to the method provided in the embodiments of the present application.

An embodiment of the present application provides a non-volatile computer-readable storage medium storing computer-executable instructions. The computer-executable instructions are executed by one or more processors, to perform the foregoing described method steps 101 to 105 in FIG. 2, and method steps 101 to 105 in FIG. 3; and implement the functions of the modules 401 to 405 in FIG. 4, and the functions of the modules 401 to 408 in FIG. 5.

The foregoing described apparatus embodiments are merely examples. The units described as separate parts may or may not be physically separate, and the parts displayed as units may or may not be physical units, may be located in one position, or may be distributed on a plurality of network units. Some or all of the modules may be selected according to actual needs to achieve the objectives of the solutions of the embodiments.

Through the description of the foregoing embodiments, a person of ordinary skill in the art may clearly understand that the embodiments may be implemented by software in combination with a universal hardware platform, and may certainly be implemented by hardware. A person of ordinary skill in the art may understand that, all or some of the processes of the method in the foregoing embodiments may be implemented by a computer program instructing relevant hardware. The program may be stored in a computer-readable storage medium. During execution of the program, the processes of the foregoing method embodiments may be included. The storage medium may be a magnetic disk, an optical disc, a read-only memory (ROM), a RAM, or the like.

Finally, it should be noted that the foregoing embodiments are merely used for describing the technical solutions of the present invention, but are not intended to limit the present invention. Under the ideas of the present invention, the technical features in the foregoing embodiments or different embodiments may also be combined, the steps may be performed in any order, and many other changes of different aspects of the present invention also exists as described above. These changes are not provided in detail for simplicity. It should be understood by a person of ordinary skill in the art that although the present invention has been described in detail with reference to the foregoing embodiments, modifications can be made to the technical solutions described in the foregoing embodiments, or equivalent replacements can be made to some technical features in the technical solutions. These modifications or replacements will not cause the essence of corresponding technical solutions to depart from the scope of the technical solutions in the embodiments of the present invention.

What is claimed is:

1. An obstacle avoidance method, applicable to an electronic device, the method comprising:
obtaining obstacle data in a flight environment of an unmanned aerial vehicle (UAV) and an image captured by the UAV, wherein the obstacle data is obtained by the UAV based on the image, the obstacle data comprises a physical location of an obstacle and an image location corresponding to the obstacle, and the physical location of the obstacle comprises a distance and an orientation of the obstacle;
recognizing the image to obtain a category of the obstacle;
obtaining a virtual image of the obstacle based on the category of the obstacle;
superimposing the virtual image on the image at the image location corresponding to the obstacle, to obtain a superimposed image; and
displaying the superimposed image on a display screen of the electronic device, so that a user controls the UAV to avoid the obstacle according to the superimposed image.

2. The method according to claim 1, wherein the superimposing the virtual image on the image at the image location corresponding to the obstacle, to obtain a superimposed image comprises:
superimposing the virtual image on the image by using an augmented reality (AR) technology, to obtain the superimposed image.

3. The method according to claim 1, further comprising:
performing a voice prompt according to the category of the obstacle and the physical location of the obstacle, so that the user learns the category and the physical location of the obstacle.

4. The method according to claim 1, further comprising:
determining whether the distance of the obstacle is less than a preset safe distance threshold;
obtaining a status of an obstacle avoidance switch and a flight speed of the UAV if the distance of the obstacle is less than the preset safe distance threshold; and
sending an obstacle avoidance instruction to the UAV and/or performing a danger prompt if the obstacle avoidance switch is turned off and the flight speed is greater than a preset flight speed threshold.

5. The method according to claim 1, further comprising:
determining a preset quantity of obstacles with the smallest distance among obstacles; then
the obtaining a virtual image of the obstacle based on the category of the obstacle comprises:
obtaining virtual images corresponding to the preset quantity of obstacles based on categories of the preset quantity of obstacles.

6. An obstacle avoidance apparatus, applicable to an electronic device, the apparatus comprising:
at least one processor; and
a memory communicatively connected to the at least one processor, wherein
the memory stores instructions executable by the at least one processor, and the instructions are executed by the at least one processor to cause the at least one processor to:
obtain obstacle data in a flight environment of an unmanned aerial vehicle (UAV) and an image captured by the UAV, wherein the obstacle data is obtained by the UAV based on the image, the obstacle data comprises a physical location of an obstacle and an image location corresponding to the obstacle, and the physical location of the obstacle comprises a distance and an orientation of the obstacle;
recognize the image to obtain a category of the obstacle;
obtain a virtual image of the obstacle based on the category of the obstacle;
superimpose the virtual image on the image at the image location corresponding to the obstacle, to obtain a superimposed image; and
display the superimposed image on a display screen of the electronic device, so that a user controls the UAV to avoid the obstacle according to the superimposed image.

7. The apparatus according to claim 6, wherein the processor is configured to:
superimpose the virtual image on the image by using an augmented reality (AR) technology, to obtain the superimposed image.

8. The apparatus according to claim 6, wherein the processor is further configured to:
perform a voice prompt according to the category of the obstacle and the physical location of the obstacle, so that the user learns the category and the physical location of the obstacle.

9. The apparatus according to claim 6, wherein the processor is further configured to:
determine whether the distance of the obstacle is less than a preset safe distance threshold;
obtain a status of an obstacle avoidance switch and a flight speed of the UAV if the distance of the obstacle is less than the preset safe distance threshold; and
send an obstacle avoidance instruction to the UAV and/or perform a danger prompt if the obstacle avoidance switch is turned off and the flight speed is greater than a preset flight speed threshold.

10. The apparatus according to claim 6, wherein the processor is further configured to:
determine a preset quantity of obstacles with the smallest distance among obstacles; and
obtain virtual images corresponding to the preset quantity of obstacles based on categories of the preset quantity of obstacles.

11. An electronic device, communicatively connected to an unmanned aerial vehicle (UAV), the electronic device comprising:
a display screen;
at least one processor; and
a memory communicatively connected to the at least one processor, wherein
the memory stores instructions executable by the at least one processor, and the instructions are executed by the at least one processor to cause the at least one processor to:
obtain obstacle data in a flight environment of the UAV and an image captured by the UAV, wherein the obstacle data is obtained by the UAV based on the image, the obstacle data comprises a physical location of an obstacle and an image location corresponding to the obstacle, and the physical location of the obstacle comprises a distance and an orientation of the obstacle;
recognize the image to obtain a category of the obstacle;
obtain a virtual image of the obstacle based on the category of the obstacle;
superimpose the virtual image on the image at the image location corresponding to the obstacle, to obtain a superimposed image; and
display the superimposed image on a display screen of the electronic device, so that a user controls the UAV to avoid the obstacle according to the superimposed image.

12. The electronic device according to claim 11, wherein the processor is further configured to:
superimpose the virtual image on the image by using an augmented reality (AR) technology, to obtain the superimposed image.

13. The electronic device according to claim 11, wherein the processor is further configured to:
perform a voice prompt according to the category of the obstacle and the physical location of the obstacle, so that the user learns the category and the physical location of the obstacle.

14. The electronic device according to claim 11, wherein the processor is further configured to:
determine whether the distance of the obstacle is less than a preset safe distance threshold;
obtain a status of an obstacle avoidance switch and a flight speed of the UAV if the distance of the obstacle is less than the preset safe distance threshold; and
send an obstacle avoidance instruction to the UAV and/or perform a danger prompt if the obstacle avoidance switch is turned off and the flight speed is greater than a preset flight speed threshold.

15. The electronic device according to claim 11, wherein the processor is further configured to:
determine a preset quantity of obstacles with the smallest distance among obstacles; then
the obtaining a virtual image of the obstacle based on the category of the obstacle comprises:
obtaining virtual images corresponding to the preset quantity of obstacles based on categories of the preset quantity of obstacles.

16. A non-transitory computer readable memory medium storing program instructions executable by processing circuitry to cause a computer system to:
obtain obstacle data in a flight environment of an unmanned aerial vehicle (UAV) and an image captured by the UAV, wherein the obstacle data is obtained by the UAV based on the image, the obstacle data comprises a physical location of an obstacle and an image location corresponding to the obstacle, and the physical location of the obstacle comprises a distance and an orientation of the obstacle;
recognize the image to obtain a category of the obstacle;
obtain a virtual image of the obstacle based on the category of the obstacle;
superimpose the virtual image on the image at the image location corresponding to the obstacle, to obtain a superimposed image; and
display the superimposed image on a display screen of the electronic device, so that a user controls the UAV to avoid the obstacle according to the superimposed image.

17. The non-transitory computer readable memory medium of claim 16, wherein the program instructions are further executable to cause the computer system to:
superimpose the virtual image on the image by using an augmented reality (AR) technology, to obtain the superimposed image.

18. The non-transitory computer readable memory medium of claim 16, wherein the program instructions are further executable to cause the computer system to:
perform a voice prompt according to the category of the obstacle and the physical location of the obstacle, so that the user learns the category and the physical location of the obstacle.

19. The non-transitory computer readable memory medium of claim 16, wherein the program instructions are further executable to cause the computer system to:
determine whether the distance of the obstacle is less than a preset safe distance threshold;
obtain a status of an obstacle avoidance switch and a flight speed of the UAV if the distance of the obstacle is less than the preset safe distance threshold; and
send an obstacle avoidance instruction to the UAV and/or perform a danger prompt if the obstacle avoidance switch is turned off and the flight speed is greater than a preset flight speed threshold.

20. The non-transitory computer readable memory medium of claim 16, wherein the program instructions are further executable to cause the computer system to:
determine a preset quantity of obstacles with the smallest distance among obstacles; and
obtain virtual images corresponding to the preset quantity of obstacles based on categories of the preset quantity of obstacles.
